(19) United States
(12) Patent Application Publication
(10) Pub. No.: US 2025/0238852 A1
(43) Pub. Date: Jul. 24, 2025

(54) USING LARGE-SCALE MACHINE-LEARNING MODELS FOR ORDER GENERATION FROM RECEIPT IMAGES

(71) Applicant: Maplebear Inc., San Francisco, CA (US)

(72) Inventors: Prithvishankar Srinivasan, Seattle, WA (US); Shishir Kumar Prasad, San Ramon, CA (US); Min Xie, Santa Clara, CA (US); Shih-Ting Lin, Santa Clara, CA (US); Saurav Manchanda, Seattle, WA (US); Amirali Darvishzadeh, San Jose, CA (US); Jian Li, Santa Clara, CA (US)

(21) Appl. No.: 19/030,474

(22) Filed: Jan. 17, 2025

Related U.S. Application Data
(60) Provisional application No. 63/625,197, filed on Jan. 25, 2024.
(60) Provisional application No. 63/622,508, filed on Jan. 18, 2024.

(51) Int. Cl. G06Q 30/0601; G06V 20/62; G06V 30/14

(52) U.S. Cl. CPC G06Q 30/0633; G06Q 30/0641; G06V 20/63; G06V 30/1448

(57) ABSTRACT

An online system may obtain an image of a receipt from a user, wherein the receipt includes a list of item identifiers and associated charges. The online system may provide a prompt to a first machine learning model including the image or extracted information from the image, and a request to provide descriptors of a list of items corresponding to the item identifiers in the image. The online system may receive from the first machine learning model as a response, the list of items and associated charges. The online system maps the list of items to one or more items in an item catalog of an online system. The online system may add the one or more items to an order associated with the user.

### CROSS REFERENCE TO RELATED APPLICATIONS

This application claims the benefit of U.S. Provisional Patent Application No. 63/622,508, filed Jan. 18, 2024, and the benefit of U.S. Provisional Patent Application No. 63/625,197, filed Jan. 25, 2024, which are hereby incorporated by reference in their entirety.

### BACKGROUND

Currently, text recognition techniques like optical character recognition (OCR) are used to find text on images. An online system may deploy an online platform to connect users to retailers, such that users can submit orders that are fulfilled by pickers. Often times, it is technically advantageous to extract information from images of receipts. However, it is difficult using current text recognition techniques to parse the receipts and extract meaningful information from the receipts. For example, there are abbreviations on the receipt that are customized to each retailer, and other information on the receipt such as retailer name that are not always relevant.

### SUMMARY

In accordance with one or more aspects of the disclosure, the techniques described herein relate to a method including obtaining an image of a receipt, wherein the receipt includes a list of item identifiers and associated charges, identifying a retailer of the associated receipt. The method further includes providing a prompt to a first machine-learning model including the image of the receipt or extracted information from the image, and a request to provide a set of item descriptors corresponding to the list of item identifiers in the image. The method further includes receiving, from the first machine learning model as a response, the set of item descriptors, wherein an item descriptor in the set is a description of a respective item in the order in the receipt, wherein the item descriptor is different from the corresponding item identifier of the respective item. The method further includes mapping the list of items to one or more items in an item catalog database associated with the retailer. Generating an online order including the one or more mapped items, and transmitting instructions to a client device to cause display of an ordering interface with the online order.

In some aspects, the techniques described herein relate to a method including obtaining an online order submitted by a user that includes one or more items. The method further includes obtaining an image of a receipt for fulfilling the online order, wherein the receipt includes a list of item identifiers and associated charges. The method further includes providing a prompt to a first machine learning model including the image or extracted information from the image, and a request to provide descriptors of a list of items corresponding to the item identifiers in the image. The method further includes receiving from the first machine learning model as a response, the list of items and associated charges. The method further includes providing a second prompt to the first machine learning model or a second machine learning model, wherein the second prompt includes the list of items and associated charges as well as a request to detect anomalies in the list of items and associated charges.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example illustration of a user's order that was purchased at a certain retailer, in accordance with one or more embodiments.

FIG. 3B is a diagram of processing images of receipts for item matching, in accordance with one or more embodiments.

FIG. 4 is a flowchart for a method of processing images of receipts for item matching, in accordance with some embodiments.

FIG. 5 is a flowchart for a method of estimating product freshness based on image analysis, in accordance with some embodiments.

### DETAILED DESCRIPTION

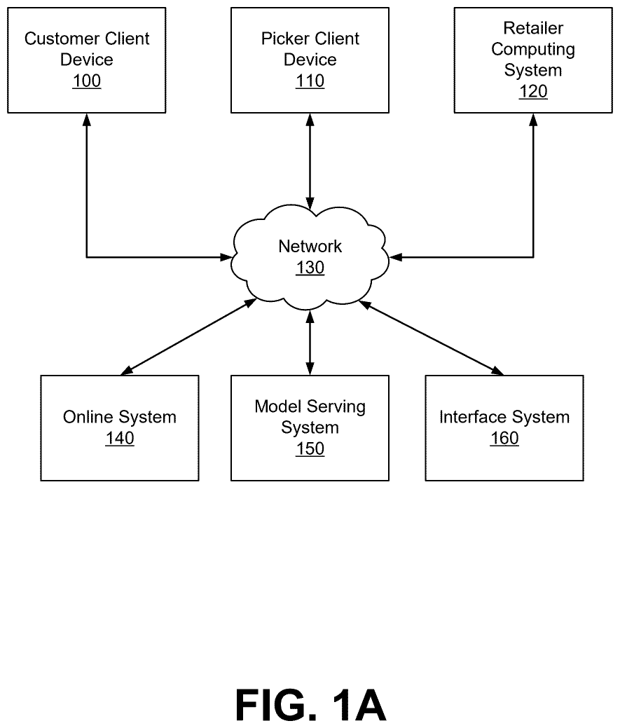

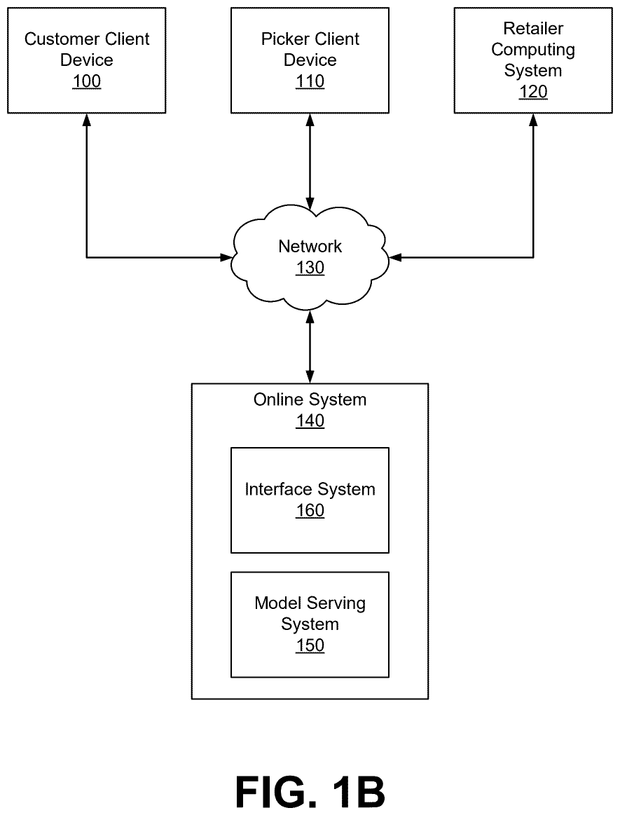

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or item that can be provided to the customer through the online system 140. The order may include item identifiers (e.g., a stock keeping unit or a price look-up code) for items to be delivered to the user and may include quantities of the items to be delivered. An item identifier may be an identifier, a code name, an abbreviation, and the like for a certain item for a given retailer that the retailer uses to keep track of the item. A different retailer may refer to the same item with a different item identifier. Additionally, an order may further include a delivery location to which the ordered items are to be delivered and a timeframe during which the items should be delivered. In one or more embodiments, the order also specifies one or more retailers from which the ordered items should be collected.

The customer client device 100 presents an ordering interface to the customer. In one or more embodiments, the ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is fulfilling the user's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the location of the picker. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, the online system 140, and/or the model serving system 150 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users or customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

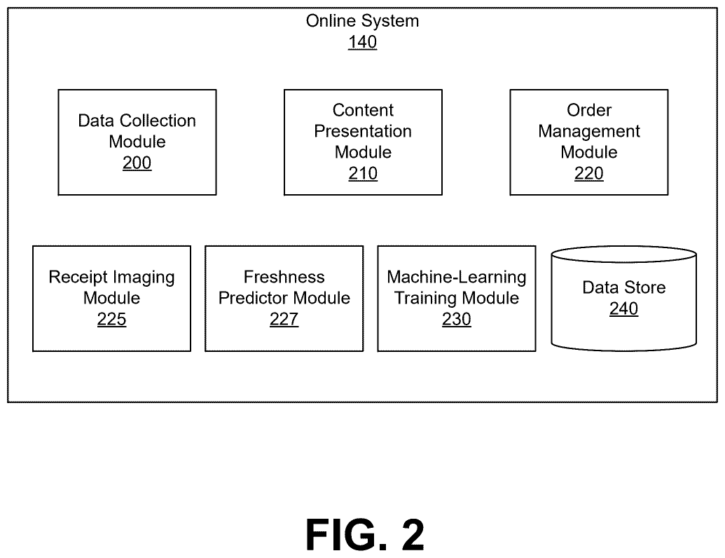

As an example, the online system 140 may allow a customer or user to order groceries from a grocery store retailer. The customer's order may specify which groceries they want delivered from the grocery store and the quantities of each of the groceries. The customer's client device 100 transmits the customer's order to the online system 140 and the online system 140 selects a picker user to travel to the grocery store retailer location to collect the groceries ordered by the customer. Once the picker user has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters for a model.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

The online system 140, in conjunction with a large-language model (LLM), maps a list of items captured in an image of a receipt to one or more items in an item catalog of the online system 140, and adds the one or more items to an online order associated with the user. In this manner, a user's physical order can be generated as an order to the online system for items that the user already purchased and are captured in the receipt, even though the items on the receipt are coded with abbreviations particular to a retailer and the receipt includes superfluous information. This way, the user also does not have to manually search and add each item in the physical receipt, which can take time and resources as the online system 140 may potentially store and manage a significant number of items. In another embodiment, the online system 140 receives, from the model serving system 150, a determination as to whether anomaly was detected in the list of items and associated charges with respect to an online order submitted by a user. The online system 140 provides, in response to receiving a determination that an anomaly was detected, the list of items and associated charges to an auditing system for further review.

In one or more embodiments, the online system 140 described herein also estimates item freshness based on image analysis. Specifically, the online system 140 trains one or more machine-learning models (e.g., convolutional neural network) for extracting features from an image. The online system 140 also trains one or more score prediction models that are configured to receive features of an image and output a freshness score indicating a degree of freshness of an item in the image.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one or more instances, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, an online system 140, and a model serving system 150. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, a receipt imaging module 225, a freshness predictor module 227, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist.

For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In some embodiments, the data collection module 200 may collect feedback from the customer client device 100. The feedback may indicate the user of the customer client device 100 submitting the respective online order. The online system 140 may generate a training example for training the LLM or other machine learning model, the training example including the prompt and the set of item descriptors.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives the images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates the communication between the customer client device 100 and the picker client device 110. As noted, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

1. Using LLMs to Create Orders from Receipt Images

The receipt imaging module 225 obtains an image of a user's receipt and generates a future order based on the user's purchase. For example, for first-time customers, the online system 140 may introduce the online ordering process by automatically creating a future order based on their recent purchase after scanning the receipt, which allows the customer to place an order with ease. The receipt may include a list of item identifiers and associated charges. In one or more embodiments, the item identifiers on the receipt are abbreviations used by the particular retailer, as often times, receipts do not have the space to include the full description of each item in the purchase. The receipt may also include an identification of a retailer. The receipt imaging module 225 may apply optical character recognition (OCR) processing to the image, or other pre-processing, in order to prepare the image for a machine-learning model in the model serving system 150.

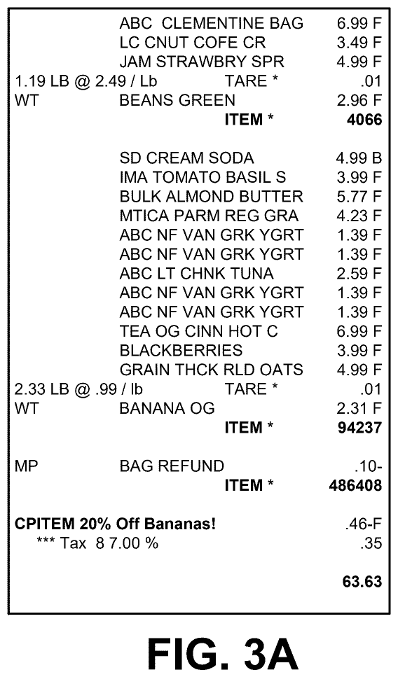

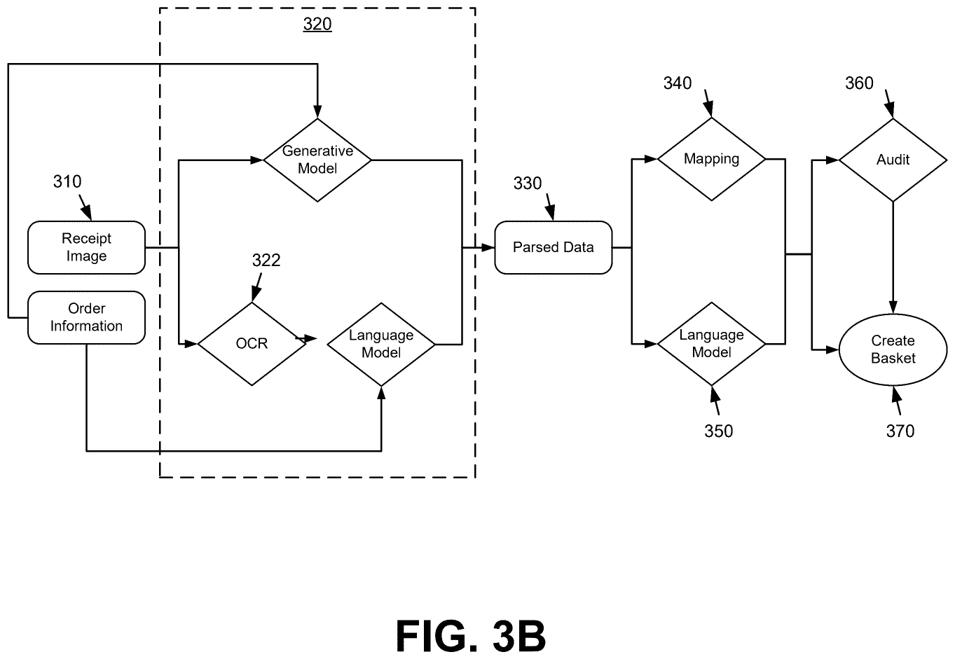

FIG. 3A illustrates an example illustration of a user's order that was purchased at a certain retailer, in accordance with one or more embodiments. For example, the receipt shows a first example identifier “ABC CLEMENTINE BAG 6.99 F” and a second example identifier “LC CNUT COFE CR 3.99 F”. As shown in FIG. 3A, the receipt typically includes identifiers that are not human-readable, as they are often codenames or abbreviations of the items customized to the retailer's system.

In one or more embodiments, the receipt imaging module 225 provides a prompt to a first machine-learning model from the model serving system 150. The prompt includes the image or extracted information from the image, and a request to provide descriptors of a list of items corresponding to the item identifiers in the receipt image. The prompt may vary based on the type of machine-learning model used. In one or more embodiments, the first machine-learning model is a cross data-modality transformer architecture that is coupled to receive text or images in a prompt and generate outputs (e.g., text) based directly from the image in the prompt. For example, the prompt for a system like GPT-V may include “extract the receipt as-is from this image . . . make best guesses based on abbreviations what grocery items are in the receipt.”

In other embodiments, the receipt imaging module 225 the receipt imaging module 225 may first extract text data using, for example, OCR, and provide the extracted information to a first machine-learning model that is a text-based LLM. As another example, the prompt may require that an image first go through OCR and may include “[b] ased on the OCR input of an image below, make best guesses as to what grocery item it is” followed by the OCR output such as “ABC FOODS America's Healthiest Grocery Store ABC CLEMENTINE BAG 6.99 F LC CNUT CFE CR 3.99 F JAM STRAWBRY SPR 4.99 F 2.49 LIBS ITEM 2.91 BEANS GREEN.96 F ITEM+4066 1.19 LB @ 2.49/LB 2.95 SD CREAM SODA 4.99 F.”

The receipt imaging module 225 receives, from the first machine-learning model as a response, the list of items and associated charges. The response may also include descriptions of abbreviations (i.e., item identifiers) found on the receipt and what item the abbreviation likely stands for. For example, the response may include “1. ABC Clementine Bag-$6.99 (ABC stands for ABC FOODS, so this is likely a bag of clementines from ABC FOODS) 2. LC CNUT CFE CR-$3.99 (LC might stand for “Liking Coconut,” CNUT is likely an abbreviation for Coconut, and CFE CR likely stands for Coffee Cream. This could be a coconut-flavored coffee creamer).”

In one or more embodiments, the receipt imaging module 225 maps the list of items to one or more items in an item catalog database of an online system 140. In one or more embodiments, the mapping of items to items in the catalog database includes searching the catalog database for items based on the descriptors received for the item identifiers. While the item identifiers are specific to retailers and may be difficult to map to items in the catalog database, because the first machine-learning model has synthesized descriptors of each item, these descriptors can be used to map each item in the receipt to items in the catalog database maintained by the online system 140. In one or more embodiments, the item descriptors may be processed using a machine-learning embedding model, which transforms the text to embedding vectors that represent the items. The embeddings generated from the item descriptors are then compared with embeddings of items in the catalog database, where the database contains its own embeddings. The online system 140 determines similarity by comparing the embeddings of the item descriptors to embeddings for items in the catalog database and based on the result of embedding comparison, the online system 1440 maps the item descriptors to the corresponding items in the catalog.

In some embodiments, the online system 140 generates an online order including one or more of the mapped items and transmits instructions to the customer client device 100 for presenting the created order to the user. This way, even if a particular user is new to the online system 140 and does not have a previous order history with the online system 140, the user can upload an image of a receipt including items the user has purchased at a retailer, such than an online order with the online system 140 can be created for the user's future purchase. In one or more embodiments, when a user is an existing user that has submitted an online order for fulfillment, the online system 140 uses the process of generating the list of item descriptors from a receipt image to detect any anomalies in the fulfilled order as captured by the receipt image relative to the order the user had submitted. In this case, the receipt imaging module 225 may obtain order information on the submitted order, provide the order information to the first machine-learning model along with information from the receipt image to generate the list of item descriptors. The receipt imaging module 225 identifies one or more anomalies in the receipt by comparing the list of item descriptors to the one or more items of the submitted order. In response to a determination of one or more anomalies, the receipt imaging module 225 provides the online order to an auditing system for further analysis.

In some embodiments, to detect anomalies, the receipt imaging module 225 provides a second prompt to a second machine-learning model or the first machine-learning model. The second prompt includes the list of item descriptors or items and associated charges, as well as a request to identify whether there is a difference between the one or more items of the submitted order and the list of item descriptors.

For example, a prompt may include “for the given receipt data, map with the shopping data (order information) given here and detect anomalies or items missing from the online order information but available in the receipt data. Also mark if there are any gift card purchases in the receipt.” In response to the second prompt, the receipt imaging module 225 identifies the presence of one or more anomalies. For example, the response from an LLM may be “The shopping data (order information) that you provided appears to correspond correctly with the receipt image information. There is more detail given in the shopping data. There are no gift card purchases mentioned neither in the given shopping data nor in the receipt image and details. There doesn't appear to be any anomalies or missing items between the shopping data and the receipt data. Both lists are consistent.” In this manner, the online system 140 can detect whether there are any anomalies between the user's submitted order and the actual fulfilled order as characterized by the receipt, leading to a higher degree of user satisfaction.

FIG. 3B is a diagram of processing images of receipts for item matching, in accordance with one or more embodiments. The online system 140 obtains the receipt image 310 from a customer client device 100 or a picker client device 110. When the receipt is for fulfilling an order submitted by an existing user, the online system 140 may also obtain order information for the order that lists the items in the order. The online system 140 provides the receipt image 310 to a machine-learning model system 320. The machine-learning model system 320 may include an OCR pre-processing step 322 depending on the variety of machine-learning model used. The online system 140 receives, from machine-learning model system 320, parsed receipt data 330, which may include the item identifiers, associated charges, and descriptions of the items or reasoning behind the determined identification.

In one or more embodiments, the online system 140 provides the parsed receipt data 330 to an item mapping step 340 to map the identified items from the receipt image 310 and parsed receipt data 330 to items in the item catalog. In other embodiments, the online system 140 provides the parsed receipt data 330 to another machine-learning model 350 for further analysis. The machine-learning model 350 may be the same as models in the machine learning model system 320 or may be a different machine learning model. The online system 140 may provide a prompt to machine-learning model 350 to analyze the parsed receipt data 330 and order information, and review the order for possible anomalies. The online system 140 may provide the results of the item mapping step 340 or the machine-learning model 350 to a human for further review and audit 360, so that anomalies may be addressed. In other embodiments, the online system 140 provides the mapped items to the application 370 to proceed with the next steps of service, for example, to create an online order for the user, so that the user can effectively purchase the order from the online system 140 without having to manually search and add each item in the user's receipt.

### 2. Predicting Freshness of Food Items Using Artificial Intelligence (AI) Models

The freshness predictor module 227 obtains a plurality of images of an item across one or more timestamps. Timestamps may indicate the time of day at which the image was taken, or may indicate a relative time of the image. For relative time stamps, each timestamp is relative to the rest of the set. In one or more instances, the item is a food item which diminishes in freshness over a period of time. The food item may include meat, fish, poultry, fruit, vegetables, or any other food item which varies in freshness and quality over time while stored on store shelves.

An image of the item is assigned a respective freshness score depending on the timestamp of the image. For example, the first image in the sequence may be assigned a score of 100 (where 100 is freshest), the second image (taken 1 hour later than first image) may be assigned score 90, the third image (taken 1 hour later than second image) may be assigned score 80, and so on. Freshness of a food item is the degree to which food items retain the original attributes without exhibiting any significant degradation or spoilage. The original attributes of a food item can be described as including color, texture, aroma, taste, and nutritional content.

In one or more embodiments, the freshness predictor module 227 provides a pair including a first image and a second image to a convolutional neural network (CNN) to extract first features associated with the first image and second features associated with the second image. Features of images may include shapes, textures, lines, edges, patterns, or colors associated with the image. For example, an image of meat may have features associated with a certain colored spot, or texture. The first image is associated with a first timestamp and the second image is associated with a second timestamp such that the second timestamp is later than the first timestamp within the period of time.

This allows for an association of the identified features of each image with the respective timestamps such that the freshness predictor module 227 may train a model to identify likely freshness (as associated with the timestamps) based on the features. The freshness predictor module 227 trains parameters of the CNN to increase a likelihood of classifying the first features of the first image as having a higher freshness than the second features of the second image. The understanding here is that the image with the earlier timestamp is by definition fresher—and so training the CNN to classify images with features associated with the earlier timestamps enables the identification of freshness in general for other images. This relies on the assumption that none of these items started out having already gone bad at the earliest time stamp. In some embodiments, the CNN is trained with additional images of food items which have gone bad and labelled as such so that the CNN may flag and exclude food items not suitable for sale or selection.

The freshness predictor module 227 generates output features for the plurality of images by applying the trained CNN to the plurality of images. In applying the trained CNN to a plurality of images of food items, the freshness predictor module 227 identifies, for each image, features associated with a potential freshness score. The freshness predictor module 227 provides, for each image in the plurality of images, the feature for the image to a score prediction model to predict an estimated freshness score. The score prediction model determines a score measuring freshness based on the provided features as identified by the CNN. Scores may be a number within a range such as 10 to 100, where one end of the range is rotten, and one end of the range is fresh. Also, certain subranges may indicate various levels of freshness and may be associated with specific recommendations. For example, a score of under 50 may indicate a suggestion not to purchase the item, or a score of over 80 may indicate a high-quality item.

The freshness predictor module 227 trains parameters of the score prediction model to reduce the loss function that indicates a difference between the estimated freshness scores and the assigned freshness scores for the plurality of images. Each of the images may have an assigned freshness score based on the associated timestamp, and in comparison to the estimated freshness score from the score prediction model, the freshness predictor module 227 trains the loss function to reduce the difference between these two sets of scores for the images.

In some embodiments, the freshness predictor module 227 determines a rate of freshness decay of a first category of food. For example, the first category of food may be steak and the freshness predictor module 227 may determine an average expected rate of decay for steak. The freshness predictor module may generate a first predicted freshness score by applying the score prediction model to features of the first category of food and then normalize the first predicted freshness score to incorporate the rate of freshness decay. For example, the freshness predictor module may process the score output by the score prediction module based on the expected rate of decay for the identified category of food.

In some embodiments, the freshness predictor module 227 determines a rate of freshness decay for a variety of categories of food including some categories of food in which some categories of food have a faster rate of freshness decay than others. For example, one category may be fish which decays more rapidly than steak. The freshness predictor module may generate a freshness score by applying the score prediction model and normalize the predicted freshness scores to incorporate the higher rate of freshness decay. For example, the normalizing of the scores for the freshness of fish as opposed to steak adjusts for the more rapid rate of decay of fish compared to steak items.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### Flowchart for Method of Processing Receipt Images for Order Creation

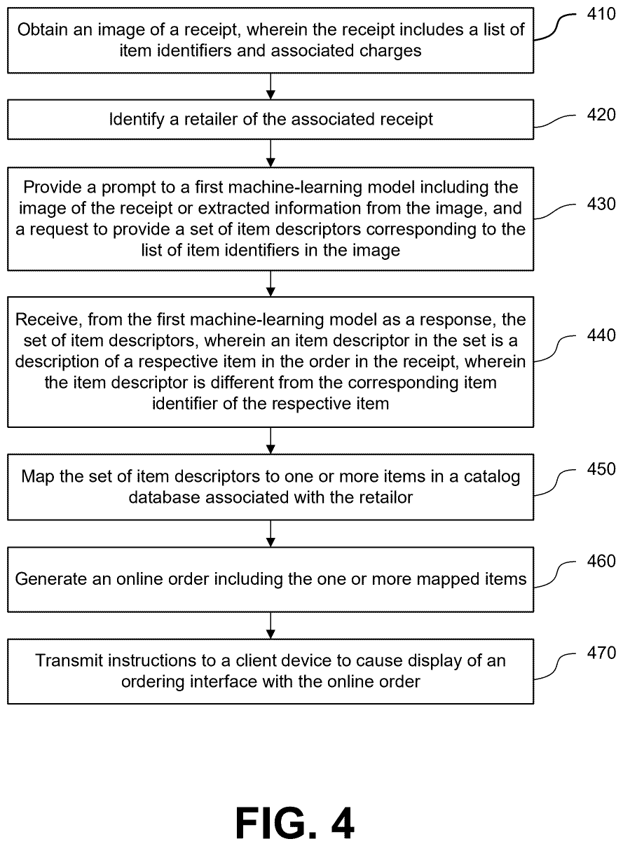

FIG. 4 is a flowchart for a method of processing images of receipts for order creation, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

In one or more embodiments, the online system 140 obtains 410 an image of a user's receipt including a list of item identifiers and associated charges and identifies 420 a retailer of the associated receipt. The online system 140 provides 430 a prompt as input to the model serving system 150 including the image of the receipt or extracted information from the image, and a request to provide a set of item descriptors corresponding to list of item identifiers in the image. The online system 140 receives 440, from the model serving system 150 as a response, the set of item descriptors and maps 450 the set of item descriptors to one or more items in a catalog database associated with the retailer. The online system then generates 460 an online order including the one or more mapped items and transmits 470 instructions to a client device to cause display of an ordering interface with the online order, in some embodiments, by updating the client online order basket.

### Flowchart for Method of Estimating Product Freshness Using CNN's

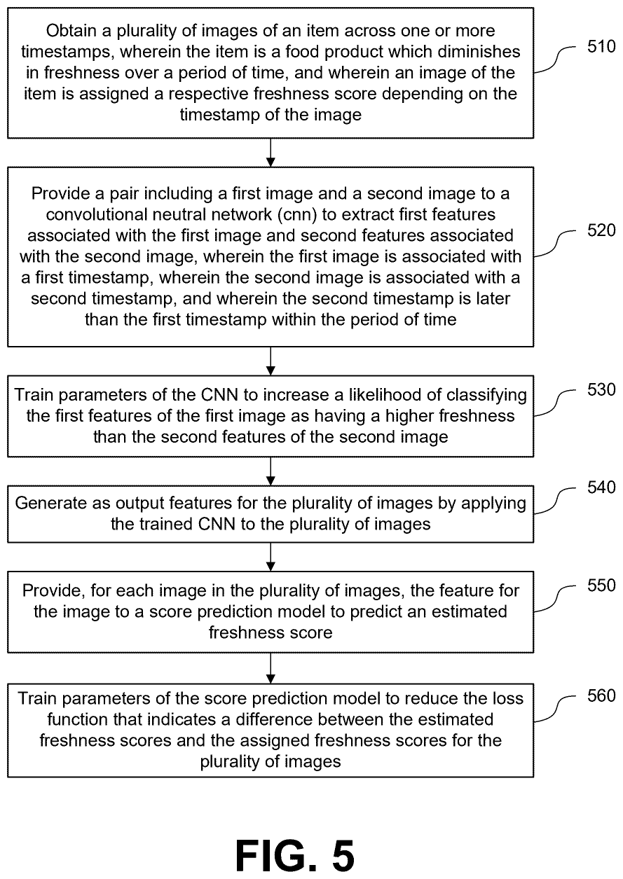

FIG. 5 is a flowchart for a method of estimating product freshness based on image analysis, in accordance with some embodiments. Alternative embodiments may include more or fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The freshness predictor module 225 obtains 510 a plurality of images of an item across one or more timestamps, wherein the product is a food product which diminishes in freshness over a period of time, and wherein an image of the item is assigned a respective freshness score depending on the timestamp of the image. The freshness predictor module 225 provides 520 a pair including a first image and a second image to a convolutional neural network (CNN) to extract first features associated with the first image and second features associated with the second image. The first image is associated with a first timestamp. The second image is associated with a second timestamp, and wherein the second timestamp is later than the first timestamp within the period of time. The freshness predictor module 225 trains 530 parameters of the CNN to increase a likelihood of classifying the first features of the first image as having a higher freshness than the second features of the second image. The freshness predictor module 225 generates 540, as output, features for the plurality of images by applying the trained CNN to the plurality of images. The freshness predictor module 225 provides 550, for each image in the plurality of images, the feature for the image to a score prediction model to predict an estimated freshness score. The freshness predictor module 225 trains 560 parameters of the score prediction model to reduce the loss function that indicates a difference between the estimated freshness scores and the assigned freshness scores for the plurality of images. In some embodiments, this estimated freshness score may be provided to the online concierge service application, a shopper, or other user, in order to aid in the selection of a food item.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program item comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an item that is produced by a computing process described herein. Such an item may store information resulting from a computing process, where the information is stored on a non-transitory, tangible computer-readable medium and may include any embodiment of a computer program item or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, comprising:
obtaining an image of a receipt, wherein the receipt includes a list of item identifiers and associated charges for an order;
identifying a retailer of the associated receipt;
providing a prompt to a first machine-learning model including the image of the receipt or extracted information from the image of the receipt, and a request to provide a set of item descriptors corresponding to the list of item identifiers in the image;
receiving, from the first machine-learning model as a response, the set of item descriptors, wherein an item descriptor in the set is a description of a respective item in the order in the receipt, wherein the item descriptor is different from the corresponding item identifier of the respective item;
mapping the set of item descriptors to one or more items in a catalog database associated with the retailer;
generating an online order including the one or more mapped items; and
transmitting instructions to a client device to cause display of an ordering interface with the online order.

2. The method of claim 1, wherein providing the prompt to the first machine-learning model comprises providing the image of the receipt to a multi-modal transformer architecture.

3. The method of claim 1, wherein the method further comprises:
extracting text data from the image using optical character recognition (OCR), wherein the text data includes the list of item identifiers, and wherein the prompt to the first machine-learning model includes the text data.

4. The method of claim 1, wherein the method further comprises:
collecting feedback from the client device, wherein the feedback indicates that a user of the client device converted on the online order;
generating a training example for training the first machine-learning model, wherein the training example includes the prompt and the set of item descriptors; and
training parameters of the first machine-learning model using the training example.

5. The method of claim 1, further comprising:
receiving, from a user, a request to fulfill a second online order, the second online order including one or more items;
obtaining a second image of a second receipt including a second list of item identifiers;
generating a second set of item descriptors corresponding to the second list of item identifiers;
identifying one or more anomalies in the second receipt by comparing the second list of item descriptors to the one or more items of the second online order; and
responsive to identifying the one or more anomalies, providing the second online order to a client device associated with an auditor.

6. The method of claim 5, wherein identifying the one or more anomalies further comprises:
providing a second prompt to a second machine-learning model or the first machine-learning model, the second prompt requesting to identify whether there is a difference between the one or more items of the second online order and the second list of item descriptors; and
identifying the one or more anomalies based on a response to the second prompt.

7. The method of claim 1, wherein mapping the set of item descriptors to one or more items in a catalog database associated with the retailer further comprises:
processing each item descriptor from the set of item descriptors using an embedding model to generate an embedding for the item descriptor;
comparing the embeddings of the item descriptors to embeddings representing items in the catalog database; and
mapping the item descriptors to the one or more items in the catalog database based on a similarity between the embeddings of the item descriptors.

8. The method of claim 1, further comprises:
obtaining a second image of a second receipt, wherein the second receipt includes a second list of item identifiers and associated charges for a second order;
generating a second online order including one or more items that correspond to items in the second receipt by at least prompting the first machine-learning model; and
providing the second online order to a picker client device.

9. A non-transitory computer-readable medium storing instructions that, when executed by a computer processor, cause the computer processor to perform operations comprising:
obtaining an image of a receipt, wherein the receipt includes a list of item identifiers and associated charges for an order;
identifying a retailer of the associated receipt;
providing a prompt to a first machine-learning model including the image of the receipt or extracted information from the image of the receipt, and a request to provide a set of item descriptors corresponding to the list of item identifiers in the image;
receiving, from the first machine-learning model as a response, the set of item descriptors, wherein an item descriptor in the set is a description of a respective item in the order in the receipt, wherein the item descriptor is different from the corresponding item identifier of the respective item;
mapping the set of item descriptors to one or more items in a catalog database associated with the retailer;
generating an online order including the one or more mapped items; and
transmitting instructions to a client device to cause display of an ordering interface with the online order.

10. The non-transitory computer-readable medium of claim 9, wherein providing the prompt to the first machine-learning model comprises providing the image of the receipt to a multi-modal transformer architecture.

11. The non-transitory computer-readable medium of claim 9, wherein the operations further comprise:
extracting text data from the image using optical character recognition (OCR), wherein the text data includes the list of item identifiers, and wherein the prompt to the first machine-learning model includes the text data.

12. The non-transitory computer-readable medium of claim 9, wherein the operations further comprise:
collecting feedback from the client device, wherein the feedback indicates that a user of the client device converted on the online order;
generating a training example for training the first machine-learning model, wherein the training example includes the prompt and the set of item descriptors; and
training parameters of the first machine-learning model using the training example.

13. The non-transitory computer-readable medium of claim 9, the operations further comprising:
receiving, from a user, a request to fulfill a second online order, the second online order including one or more items;
obtaining a second image of a second receipt including a second list of item identifiers;
generating a second set of item descriptors corresponding to the second list of item identifiers;
identifying one or more anomalies in the second receipt by comparing the second list of item descriptors to the one or more items of the second online order; and
responsive to a determination of the one or more anomalies, providing the second online order to an auditor.

14. The non-transitory computer-readable medium of claim 13, wherein identifying the one or more anomalies further comprises:
providing a second prompt to a second machine-learning model or the first machine-learning model, the second prompt requesting to identify whether there is a difference between the one or more items of the second online order and the second list of item descriptors; and
identifying the one or more anomalies based on a response to the second prompt.

15. The non-transitory computer-readable medium of claim 9, wherein operations for mapping the set of item descriptors to one or more items in a catalog database associated with the retailer further comprises:
processing each item descriptor from the set of item descriptors using an embedding model to generate an embedding for the item descriptor;
comparing the embeddings of the item descriptors to embeddings representing items in the catalog database; and
mapping the item descriptors to the one or more items in the catalog database based on a similarity between the embeddings of the item descriptors.

16. The non-transitory computer-readable medium of claim 9, wherein the operations further comprise:
obtaining a second image of a second receipt, wherein the second receipt includes a second list of item identifiers and associated charges for a second order;
generating a second online order including one or more items that correspond to items in the second receipt by at least prompting the first machine-learning model; and
providing the second online order to a picker client device.

17. A computer system comprising:
a computer processor; and
a non-transitory computer readable medium storing instructions that, when executed by the computer processor, cause the computer processor to perform operations comprising:
obtaining an image of a receipt, wherein the receipt includes a list of item identifiers and associated charges for an order;
identifying a retailer of the associated receipt;
providing a prompt to a first machine-learning model including the image of the receipt or extracted information from the image of the receipt, and a request to provide a set of item descriptors corresponding to the list of item identifiers in the image;
receiving, from the first machine-learning model as a response, the set of item descriptors, wherein an item descriptor in the set is a description of a respective item in the order in the receipt, wherein the item descriptor is different from the corresponding item identifier of the respective item;
mapping the set of item descriptors to one or more items in a catalog database associated with the retailer;
generating an online order including the one or more mapped items; and
transmitting instructions to a client device to cause display of an ordering interface with the online order.

18. The computer system of claim 17, wherein providing the prompt to the first machine-learning model comprises providing the image of the receipt to a multi-modal transformer architecture.

19. The computer system of claim 17, wherein the operations further comprise:
extracting text data from the image using optical character recognition (OCR), wherein the text data includes the list of item identifiers, and wherein the prompt to the first machine-learning model includes the text data.

20. The computer system of claim 17, wherein the operations further comprise:
collecting feedback from the client device, wherein the feedback indicates that a user of the client device converted on the online order;
generating a training example for training the first machine-learning model, wherein the training example includes the prompt and the set of item descriptors; and
training parameters of the first machine-learning model using the training example.
